(19) United States
(12) Patent Application Publication
(10) Pub. No.: US 2016/0257600 A1
(43) Pub. Date: Sep. 8, 2016

(54) MANUFACTURING IRREGULAR-SHAPED PREFORMS

(71) Applicant: OFS Fitel, LLC, Norcross, GA (US)

(72) Inventor: Dennis J. Trevor, Clinton, NJ (US)

(73) Assignee: OFS Fitel, LLC, Norcross, GA (US)

(21) Appl. No.: 14/640,615

(22) Filed: Mar. 6, 2015

(51) Int. Cl. C03B 37/012

(52) U.S. Cl. CPC C03B 37/01248; C03B 37/01257; C03B 37/01282; C03B 2201/02; C03B 2203/04

(57) ABSTRACT

Irregular-shaped optical fiber preforms and processes for manufacturing such preforms are disclosed. In some embodiments, the irregular-shaped preforms are manufactured by using thin-walled tubes that have irregularities. For some embodiments, these irregularities are varying wall thicknesses. For other embodiments, these irregularities are non-circular cross-sectional shapes. Yet for other embodiments, these irregularities are combinations of varying wall thicknesses and non-circular cross-sectional shapes.

### CROSS REFERENCE TO RELATED APPLICATIONS

This application incorporates by reference the following U.S. patent applications, which are filed concurrently with this application:

U.S. patent application Ser. No. [TREVOR 12], having the title “Using Porous Grains in Powder-in-Tube (PIT) Process”;

U.S. patent application Ser. No. [TREVOR 9], having the title “Using Silicon Tetrafluoride in Powder-in-Tube (PIT) Process”;

U.S. patent application Ser. No. [TREVOR 10], having the title “Easy Removal of a Thin-Walled Tube in a Powder-in-Tube (PIT) Process.”

### BACKGROUND

1. Field of the Disclosure

The present disclosure relates generally to manufacturing and, more particularly, to manufacturing preforms.

2. Description of Related Art

Optical fiber preforms possess properties that determine the characteristics of optical fibers that are eventually drawn from those preforms. The quality of an optical fiber correlates with the quality of materials that are used in manufacturing the preform from which the optical fiber is drawn. Furthermore, such preforms have almost universally been manufactured with a circular cross-section. As one can imagine, using higher-quality starting materials results in increased costs. In view of this, there are ongoing efforts to reduce the manufacturing costs of the preforms, and concurrently to improve the quality of the preforms.

### SUMMARY

Disclosed herein are various embodiments of systems and processes that employ porous silica grain in a preform manufacturing process. In some embodiments, the porous silica grains are purified, sintered, and consolidated.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an empty silica tube that has been sealed at the bottom such that it is gas permeable, but impermeable to grains.

FIG. 2 shows a core rod placed within the silica tube of FIG. 1.

FIG. 3 shows the silica tube of FIG. 2 being filled with silica grains.

FIG. 4 shows an enlarged view of the silica grains of FIG. 3.

FIG. 5 shows a mesoporous structure of one of the silica grains of FIG. 4.

FIG. 6 shows a purification process being applied after the silica-grain-filling process of FIG. 3.

FIG. 7 shows a vacuum being applied to the silica-grain-filled tube after the purification process shown in FIG. 6.

FIG. 8 shows sintering and condensation of the silica-grain-filled tube in the presence of the vacuum applied in FIG. 7.

FIG. 8A shows an overhead view of the silica-grain-filled tube of FIG. 8.

FIG. 9 shows an overhead view of an irregular-shaped silica-grain-filled tube.

FIG. 10 shows an overhead view of another irregular-shaped silica-grain-filled tube.

### DETAILED DESCRIPTION OF THE EMBODIMENTS

Currently, optical fibers are designed with very stringent specifications in optical performance, mechanical strength, physical dimensions, and reliability. With increasing demands for bandwidth, these specifications continue to become increasingly stringent. In order for optical fibers to meet such stringent specifications, manufacturers employ exacting controls over the manufacturing process. While strict controls over the process contribute to the fiber quality, another factor that affects the quality of the fiber is the quality of the starting materials that are used to manufacture the optical fiber preforms from which the fibers are drawn. For example, if a preform contains impurities or defects, then those imperfections can result in degraded performance. Specifically, surface contamination and refractory particles, which act as stress centers during the fiber drawing process, affect the mechanical properties of optical fibers and contribute to fiber breakage. As such, much effort is devoted to using high-purity starting materials with minimal contaminants.

In one preform manufacturing process, known as a powder-in-tube (PIT) process, a silica tube is filled with silica powder and consolidated at high temperatures in the presence of a vacuum, thereby resulting in an optical fiber preform. Because conventional PIT processes typically use fully densified vitreous or crystalline silica, any refractory particle that is trapped within those densified material becomes a part of the preform. Consequently, those trapped refractory particles degrade the mechanical properties of the optical fiber that is eventually drawn from the preform. Thus, in order produce industrially-acceptable preforms, the conventional PIT processes use ultra-pure silica powder. In other words, because the resulting optical fiber inherits the impurities in the silica powder in conventional PIT processes, those processes strive to use silica of the highest purity as the starting materials. Unfortunately, ultra-pure silica is expensive. Hence, the cost of the resulting fiber is directly traceable to the cost of the silica starting materials.

Another drawback in the conventional PIT process is that it is difficult to manufacture an irregular-shaped preform (e.g., preforms with oval cross-sections, rectangular cross-sections, star-shaped cross-sections, etc.). When such irregular shapes are desired, additional steps are often required to properly form the preform into its desired shape. These additional steps can include acid etching or grinding to remove the excess glass in the preform. Such additional processes are imperfect in nature and result in the expenditure of additional time and money to achieve the desired shape. Furthermore, in cases where glass-recycling services are not implemented, there can be additional expense associated with wasted material.

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica particles, the disclosed processes use porous silica grains that have a substantially monodisperse size distribution. Stated differently, porous silica grains with substantially uniform grain size are used as the starting materials for the disclosed PIT processes. In one preferred embodiment, 150-micrometer-size mesoporous silica grains are used as the particular starting material. It should be appreciated that the preferable starting materials are mesoporous silica grains (which have pores sizes of between approximately two (2) nanometers (nm) and fifty (50) nm), but larger or smaller pore sizes will also work.

To the extent that pores in the mesoporous silica grains are connected to the surface of the grains, the connected porosity provides a mechanism that allows impurities that are smaller than the pore size to diffuse to the surface of the silica grain, thereby permitting purification of the mesoporous silica grains. Since the mesoporous structure permits purification, unlike the fully densified silica crystals, the disclosed PIT process is not as restricted to the use of ultra-high-purity silica that is typically required for conventional PIT processes. Thus, the disclosed PIT process results in cost reductions that are typically not achievable in conventional processes for similar quality optical fiber preforms. Additionally, the porosity of the mesoporous silica permits doping during the PIT process. And, since the mesoporous silica has a higher surface-to-volume ratio than fully densified silica, the temperature at which the mesoporous silica softens is lower than the temperature at which the silica tube softens. For this reason, the mesoporous silica can be sintered concurrently with the consolidation of the silica tube. The ability to sinter and consolidate in a single step further reduces costs because only one high-temperature step is needed to accomplish both sintering and consolidation.

Other benefits of the disclosed embodiments include the capability to produce irregular-shaped preforms without excess cost and waste associated with traditional methods that require grinding or acid etching to form the desired shape. By introducing an asymmetry or irregularity to the walls of the hollow tube, an irregular-shaped preform can be fabricated at a cost-savings, as compared to etching and grinding techniques. Consequently, this eliminates the need for further modification of the preform through grinding, acid etching, or other expensive and imperfect processes, which can negatively impact the fiber's performance.

As described in greater detail herein, using substantially homogeneous mesoporous silica grains provides a more economical approach to manufacturing optical fiber preforms. Having provided an overview of several embodiments, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

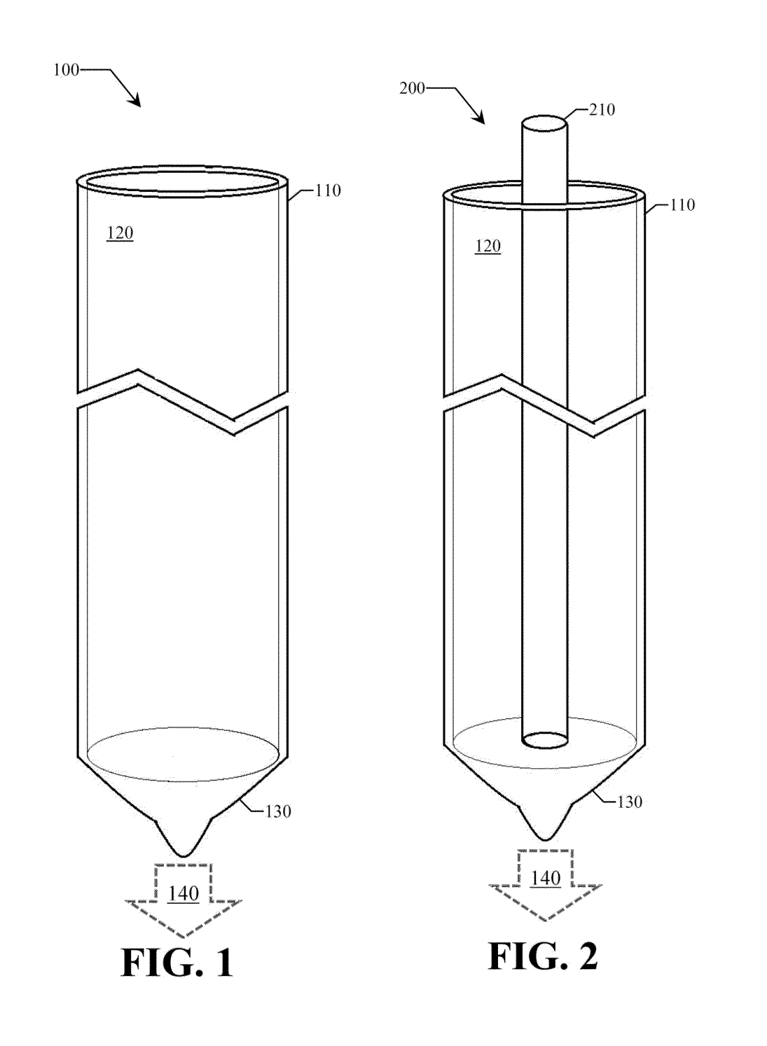

Generally, FIGS. 1 through 8 illustrate several embodiments of the inventive PIT preform-fabrication process, and FIGS. 4 and 5 show an example structure of mesoporous silica grains with a substantially monodisperse size distribution (or uniform grain size), which are used as the starting materials for the disclosed PIT processes. Also, with reference to FIGS. 4 and 5, a sol-gel process for manufacturing mesoporous silica having substantially-uniform grain sizes is discussed.

FIG. 1 shows one embodiment of a hollow tube 100 that is used in a powder-in-tube (PIT) preform manufacturing process. As shown in the embodiment of FIG. 1, the hollow tube 100 is a silica tube 110 with a cavity 120 and a grain-sealed bottom 130 (which is sealed to the grain but preferably permeable to gases). In other words, for preferred embodiments, the grain-sealed bottom 130 permits gas flow 140 but prohibits grains from escaping through the bottom 130. This silica tube 110 is preferably fabricated from fused quartz or silica. The quality of the silica tube 110 can vary, depending on whether the glass from the silica tube 110 that eventually becomes a part of the preform will be removed by etching or machining For illustrative purposes, the silica tube 110 described herein is a thin-walled tube that is approximately 1.2 meters (m) in length with a wall thickness of approximately 2.5 millimeters (mm). Experiments have been successfully conducted using thin-walled tubes that have inner diameters that ranged from approximately 25 mm to approximately 90 mm. While these dimensions are provided to more clearly illustrate one embodiment of a PIT process, it should be appreciated that the dimensions of the silica tube 110 may be modified based on the manufacturing tolerances and preferences.

FIG. 2 shows a tube-and-core-rod setup 200, where a core rod 210 placed within the silica tube 110. Placing the core rod 210 in the silica tube 110, as shown in FIG. 2, permits manufacturing of optical fiber preforms that can be drawn into an optical fiber. Conversely, a thin-walled silica tube 110 without a core rod 210 can be used in manufacturing a silica rod that can be used for core material or jackets, for example, a rod-in-tube process. For illustrative purposes, the PIT processes described herein are implemented using the rod setup 200. However, it should be appreciated that similar PIT processes can be implemented with the hollow tube 100 in the absence of the core rod.

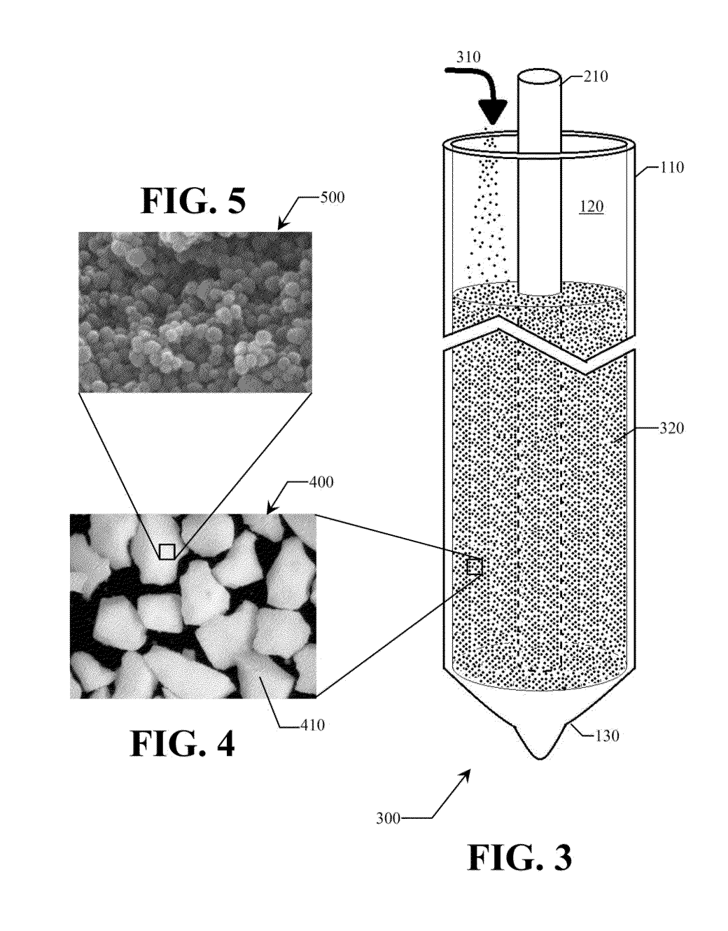

With the starting tubes and configurations of FIGS. 1 and 2 in mind, attention is turned to FIG. 3, which shows a tube-filling setup 300, where the silica tube 110 of FIG. 2 is filled with silica grains 310. As shown in FIG. 3, the thin-walled silica tube 110 has a grain-sealed bottom 130, which permits filling of the cavity 120 from the top of the silica tube 110. Since the embodiment of FIG. 3 includes a core rod 210, entering silica grain 310 fills the space in the silica tube 110 surrounding the core rod 210, and the silica grain 320 accumulates from the bottom upward. For some embodiments, a mild mechanical disruption can be introduced during the filling process to permit the settled silica grains 320 to achieve a random-close-packed density. In addition, the rod position can be examined and adjusted, for example, to center it in the outer tube, during the filling operation. The resulting configuration is random-close-packed silica grains 320 in the silica tube 110, and hence the name powder-in-tube (PIT).

Unlike conventional PIT processes that use dense fused vitreous or crystalline silica grains, the tube-filling setup of FIG. 3 uses mesoporous silica grains 410, which are shown in greater detail in enlarged view 400 of FIG. 4. In one preferred embodiment, the mesoporous silica grains 410 have a substantially monodisperse size distribution, meaning that the mesoporous silica grains 410 have a substantially uniform (or homogeneous) grain size. Since the purification time for the mesoporous silica grains 410 is directly proportional to the diffusion length of the contaminants that are being purged, a larger grain size results in a longer purification time, while a smaller grain size results in a correspondingly-shorter purification time. Also, if faster sintering is desired, then smaller pore and primary particle sizes are preferable, since smaller particles sinter faster than larger particles. In one preferred embodiment, approximately-250-micron-size mesoporous silica grains 410 comprising approximately 10 nm to 50 nm pores made of 50 nm fundamental particles are used as the starting materials for the disclosed PIT processes. However, it should be appreciated that the grain size can be varied as desired, with a preferred grain size being between approximately 15 microns and 550 microns.

It is worthwhile to note is that the random-close-packed density is the same irrespective of the grain size, as long as the grains are substantially homogeneous. As such, whether the grains are uniformly 25 microns, 70 microns, 150 microns, or 250 microns, as long as the size distribution is monodisperse, the packing density is substantially the same.

One way of manufacturing the substantially homogeneous mesoporous silica grains 320 is by using a sol-gel process. Since sol-gel processes are well-known in the art, only a truncated discussion of the process is provided herein to properly frame the inventive PIT processes. Within the sol-gel process, fumed silica is dispersed in water using an appropriately-small quantity of tetramethyl ammonium hydroxide. This dispersion is mixed under high-shear conditions and then centrifuged to remove particulates of higher density, typically comprising metals, metal oxides, and large particulates of comparable density, usually of incompletely dispersed silica agglomerates. The mixture is filtered again, but this time to remove dissolved gases and bubbles, and also to further remove particles up to the cut-off size that is relevant to fiber strength degradation. Thereafter, the mixture is formed into a solid material by optionally gelling, settling, or mechanically compacting. The solid form is dried, which results in a mesoporous silica cake. And, it is from this mesoporous silica cake that the mesoporous silica grains 320 are derived. Specifically, the dried cake is crushed and ground into a desired uniform grain size (e.g., 250-micron-size grains). At this point, the impurities in the dried gel include small amounts of water and organic species (a few percent by weight of each), a fraction of a percent surface hydroxyl, and parts-per-million (ppm) levels of metals and metal oxides. In other words, at this point, the mesoporous silica grains 320 still have impurities. However, as discussed below, those impurities can be removed during the disclosed PIT process.

A closer examination of the pore structure is helpful in understanding the purification mechanism in the disclosed PIT process. For this reason, FIG. 5 shows a pore structure 500 of one of the mesoporous silica grains 410. As shown in FIG. 5, the pores in the mesoporous silica grains 410 are connected to the surface of the grains. The connected porosity of the pore structure 500 provides a mechanism that allows impurities that are smaller than the pore size to diffuse to the surface of the silica grain with rapid access of reactive chemicals to promote this purification via removal or chemically transforming the impurities into benign components with respect to fiber performance. As noted earlier, if the grain size is sufficiently small to permit implementation of diffusion-based purification processes, then the mesoporous silica grains 410 can be purified during the PIT process, thereby ameliorating the need for ultra-pure silica as the starting materials. In other words, since the mesoporous structure permits purification, unlike the fully densified silica crystals in conventional PIT processes, the disclosed mesoporous structure results in a cost reduction when compared to the use of fully densified silica grain.

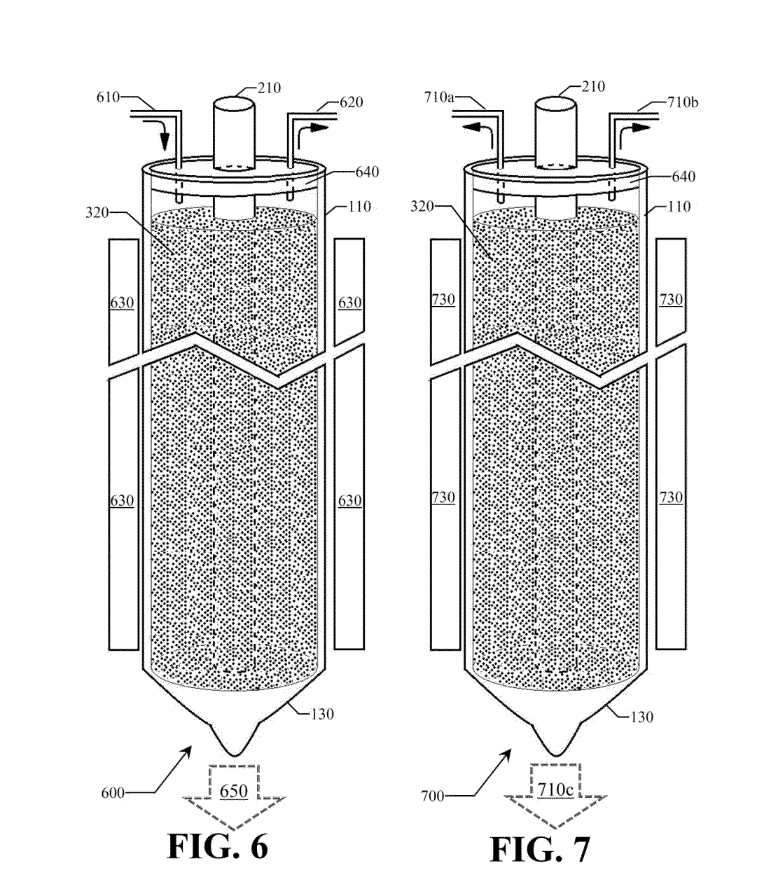

With this in mind, attention is turned to FIG. 6, which shows a purification setup 600 that is used to purify the mesoporous silica grains 320 that have filled the silica tube 110, as shown in FIG. 3. In the configuration of FIG. 6, an upper seal 640 is placed on the thin-walled silica tube 110, which, in conjunction with the grain-sealed bottom 130, creates a substantially closed environment within the silica tube 110. The mesoporous silica grains 320 are held within the closed environment. The upper seal 640 comprises two input ports (a first input port 610 and a second input port 620) through which chlorine, nitrogen, thionyl chlorine, and air are introduced into the closed environment. Since the grain-sealed bottom 130 is gas-permeable, in one preferred embodiment, any remaining water, organic species, surface hydroxyl, metals, metal oxides, and reaction products are expelled 650 from the closed environment through the grain-sealed bottom 130. The purification setup 600 also includes a heating element 630 (e.g., torch or furnace) that is used in the purification process. In an alternative embodiment, the second port 620 may be used in conjunction with the grain-sealed bottom 130 to expel the remaining water, organic species, surface hydroxyl, metals, metal oxides, and reaction products.

Before discussing the purification process, it is worthwhile to note another advantage of using mesoporous silica grains 320 with the input ports 610, 620. Namely, the pore structure 500 permits doping during the PIT process, and the input ports 610, 620 provide a mechanism by which dopants can be introduced to the mesoporous silica grains 320. As one can see, the grain-sealed bottom 130 expels 650 excess dopants and permits regulation of pressure within the closed environment.

As for the purification process, in operation, once the mesoporous silica grains 320 are packed in the thin-walled tube 110, the purification setup 600 is heated to approximately 600 degrees Celsius (° C.) to remove residual water and organic species in an anaerobic environment followed by an oxidizing environment. Since those compounds are trapped in a mesoporous material 500, the heat causes those impurities to diffuse to the surface of the mesoporous silica grain 410 for eventual evacuation through the output vent. Since 600° C. is well below the melting point of silica, the mesoporous silica material 500 maintains its shape during this evacuation process.

Once the water and organic species are removed, chlorine is introduced into the closed environment through the input port 610, and the temperature of the heating element is raised to approximately 1000° C. At this temperature, the remaining water that is chemically bonded with the silica now reacts with the chlorine, thereby resulting in the dehydroxilation of the silica. The byproducts from the dehydroxilation process are expelled through the output vent 620.

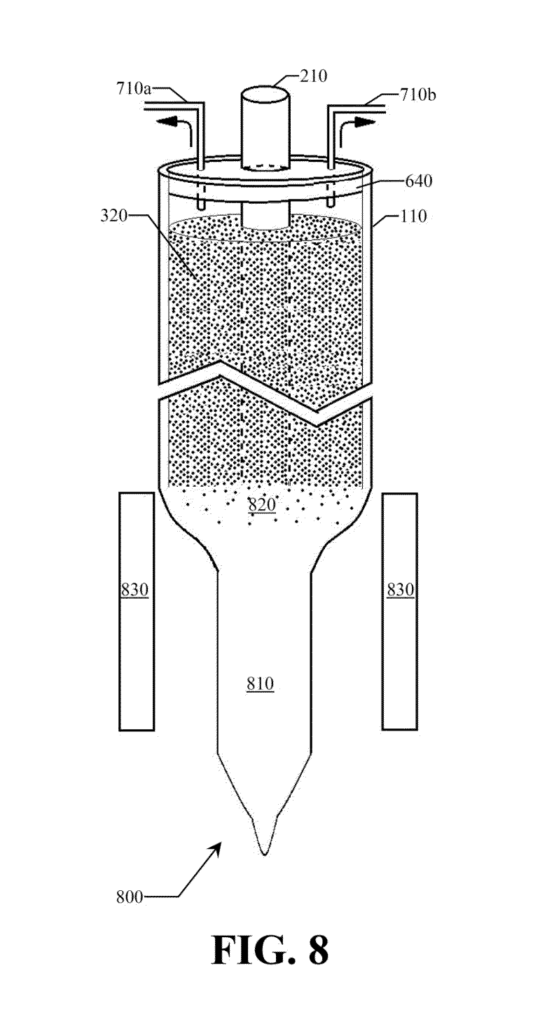

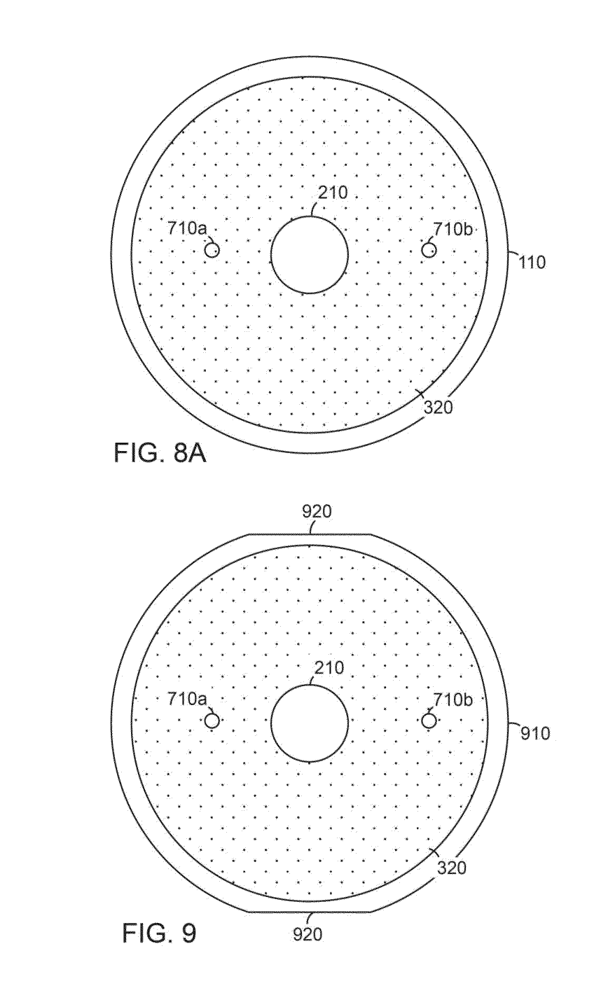

In the next purification step, metal and metal oxide refractories (such as zirconia and chromia) are removed or transformed in a nitrogen environment by introducing thionyl chloride into the closed environment via the input port 610, and increasing the temperature of the heating element 630 to approximately 700° C. for thionyl chloride and approximately 1250° C. for chlorine. The purification process yields a fully dehydroxilated, high-purity, mesoporous silica grain 320, which is ready for sintering and consolidation, which are discussed in greater detail with reference to FIGS. 7 and 8.

FIG. 7 shows a vacuum application setup 700 in which a vacuum is applied to the silica-grain-filled tube. The input ports 610, 620 (FIG. 6) now serve as vacuum ports 710a, 710b, along with the grain-sealed bottom 130 (now labeled as 710c). Thus, a vacuum can be drawn through these outlets 710a, 710b, 710c, thereby reducing the pressure within the silica tube 110. Here, the upper seal 640 provides a closed environment, thereby allowing for depressurization through the vacuum ports 710a, 710b, 710c. In one preferred embodiment, both upper vacuum ports 710a, 710b are sealed, and evacuation occurs through the grain-sealed bottom 710c, thereby avoiding disruption of the packed grain with a pressure gradient being established along the direction of gravity.

Since the mesoporous silica (due to its small fundamental particle size) has a higher surface-to-volume ratio than fully densified silica, the consolidation temperature of the mesoporous silica grains 320 is lower than the temperature at which the silica tube softens. The vacuum within the silica tube 110 assists shrinking of the tube onto the consolidated grain. This is accomplished by increasing the heating elements 730 to approximately 1725° C. while drawing a vacuum, the mesoporous silica grains 320 can be sintered before the fully densified silica tube 110 reaches its melting point, for some embodiments.

As shown in FIG. 8, given the proper combination of high temperatures and vacuum, the mesoporous silica grains 320 sinter 820 substantially concurrently with the consolidation of the silica tube 110. This results in a high-purity, fully-densified silica body 810. This ability to sinter and consolidate in a single step further reduces costs, because only one high-temperature step is needed to accomplish both sintering and consolidation. This process is also advantageous because it does not require use of Helium during the sintering process of the grain.

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica particles, the disclosed processes use mesoporous silica grains that have a substantially monodisperse size distribution. Stated differently, mesoporous silica grains with substantially uniform grain size are used as the starting materials for the disclosed PIT processes. In one preferred embodiment, 150-micrometer-size mesoporous silica grains are used as the particular starting material.

As described with reference to FIGS. 1 through 8, the use of mesoporous silica grains 320 permits the application of purification processes that cannot be applied to fully densified silica crystals. Thus, the disclosed PIT process is not as restricted to the use of ultra-high-purity silica that is typically required for conventional PIT processes. Consequently, the disclosed PIT process provides a cost reduction that is typically not achievable in conventional processes for similar-quality optical fiber preforms. Additionally, the porosity of the mesoporous silica 500 permits doping during the PIT process, concurrent sintering of the mesoporous silica grains 320 with the consolidation of the silica tube 110, and further cost reductions by using a single high-temperature sintering-and-consolidation step. Ultimately, the use of mesoporous silica grains 320 as the starting material for the disclosed PIT process no longer requires the manufacturer to use the highest-purity starting materials for preform fabrication but, rather, allows a lower-cost material to be purified to the necessary specifications, thereby reducing a large portion of the manufacturing costs.

The processes described above produce preforms with circular cross-sections. FIG. 8A shows an overhead view of the setup of FIG. 8. As disclosed above, when the vacuum 700 and heat 830 are applied to the silica tube 110, the silica grains 320 sinter and the silica tube 110 consolidates (or collapses) with the sintered silica grains 320 upon the solid glass core rod 210. In the absence of any pressure or any modifications to the silica tube 110, the sintering and consolidation occur evenly, thereby forming a cylindrical preform with a circular cross-section, which is commonly available today.

However, if an irregular-shaped preform is desired without the additional time of expense of post-manufacturing modifications, then the desired shape can be achieved by altering the silica tube, as described below. In one preferred embodiment, the following methods are applied at the applicable stages of the disclosed improved PIT process. However, the process of producing an irregular-shaped preform can be used with any PIT process to achieve comparable results, and therefore should not be considered to be limited only to the disclosed improved PIT process.

In one embodiment, if a preform with a symmetrical non-circular cross-section is desired, then that shape can be achieved by starting the process with a thin-walled tube with a symmetrical but non-circular cross-section as the starting material. FIG. 9 shows an overhead view of a silica tube 910 with a symmetrical but non-circular cross-section, which can be used to manufacture a preform with an oval cross-section. Specifically, the silica tube 910 is created by grinding, or otherwise removing material from, two opposite sides 920 of the silica tube 910. By modifying two sides of the silica tube 910, while applying no change elsewhere, the resulting silica tube 910 has two thin sections in the wall of the silica tube 910. Thus, during sintering and consolidation, these thinner walls collapse earlier in the process than the remainder of the wall. The resulting consolidation results in an oval-shaped preform.

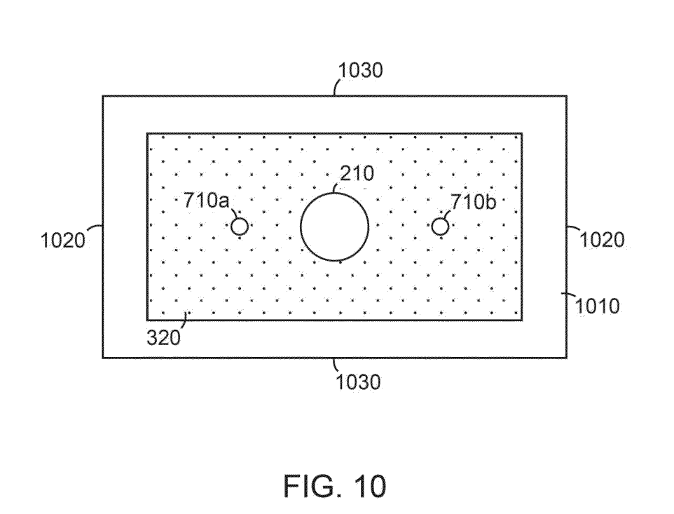

FIG. 10 shows another embodiment in which a preform with a rectangular cross-section is manufactured. Here, the silica tube 1010 has four (4) flat sides. Two sides 1020 of the silica tube 1010 are shorter, while the two remaining sides 1030 are longer. When a vacuum and heat are applied as described in FIGS. 7 and 8, the silica tube 1010 collapses about the silica grains 320 into a rectangular shape, thereby resulting in a preform with a rectangular cross-section.

In another embodiment, preforms with asymmetrical cross-sections can be achieved by strategically introducing irregularities into the walls of the thin-walled silica tube. Rather than commencing the PIT process with irregular-shaped silica tubes, as described previously, a typical silica tube with a circular cross-section can be modified to create asymmetries or weaknesses within its wall. In other words, as with the oval-shaped or rectangular-shaped silica tubes, the manner in which the silica tube consolidates with the silica grains can be controlled by introducing asymmetries or other weaknesses in the wall of the silica tube, creating thinner and thicker portions that will collapse at different times and under different conditions within the PIT process. With an understanding of how glass behaves under various conditions, the starting silica tube can be modified in such a way that the end-result is a preform with almost limitless cross-sectional shapes (e.g., oval, square, rectangle, star, etc.).

In another embodiment, irregular-shaped preforms in which an offset core is desired can also be achieved by altering one side of a silica tube. In order to achieve a preform with an offset core, only one side of the silica tube is modified, thereby creating a thin portion on one side with the remainder of the tube being unmodified. When the vacuum 700 and heat 830 are applied as described above and in FIGS. 7 and 8, the thinner wall of the silica tube collapses much earlier than the unaltered side. Thus, upon consolidation, the result is a preform with an offset core.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, it should be appreciated that the term mesoporous means a porous structure in which the pores are connected to the surface of the grain. Also, while oval and rectangular cross-sections are shown and described in detail, one having skill in the art will understand that an almost limitless number of variations can be introduced to the starting silica tube, thereby resulting in an almost limitless number of irregular-shaped preforms that can be manufactured using the disclosed processes. All such changes, modifications, and alterations should therefore be seen as within the scope of the disclosure.

1. A powder-in-tube preform manufacturing process, comprising:
filling a silica tube with silica grains, wherein the silica tube has a non-circular cross-section, wherein the silica grains are mesoporous;
reducing pressure within silica tube;
heating the silica grains;
sintering the heated silica grains in the reduced pressure; and
consolidating the silica tube to form a preform, the preform having a non-circular cross-section.

2. A process, comprising:
filling a silica tube with silica grains, wherein the silica tube has a non-circular cross-section, wherein the silica grains are mesoporous;
reducing pressure within the silica tube;
sintering the silica grains in the reduced pressure; and
consolidating the silica tube to form a preform, the preform having a non-circular cross-section.

3. The process of claim 2, the preform having an oval cross-section.

4. The process of claim 2, the preform having a rectangular cross-section.

5. The process of claim 2, the preform having a star-shaped cross-section.

6. (canceled)

7. (canceled)

8. (canceled)

9. A system, comprising:
silica grains;
a silica tube having an irregular cross section, the silica tube to hold the silica grains;
an input port to introduce gases into the silica tube;
an output vent to evacuate impurities from the silica tube; and
a heating element to heat the silica tube and the silica grains.

10. The system of claim 9, the irregular cross section being oval.

11. The system of claim 9, the irregular cross section being rectangular.

12. The system of claim 9, the silica tube comprising a wall, the irregular cross section comprising an irregularity in the wall.

13. The system of claim 12, the irregularity being acid-etched into the wall.

14. The system of claim 12, the irregularity being mechanically ground into the wall.

15. The system of claim 9, the heating element being a torch.

16. The system of claim 9, the heating element being a furnace.

17. The system of claim 9, the input port to further depressurize the silica tube.

18. The system of claim 9, the output vent to further depressurize the silica tube.

19. The system of claim 9, the silica tube being a thin-walled tube.

20. The system of claim 9, the silica grains being substantially homogeneous mesoporous silica grains.

21. A preform manufactured by the process of claim 1.

22. A preform manufactured by the process of claim 2.

23. A preform manufactured by the process of claim 4.
